(19) United States
(12) Patent Application Publication
(10) Pub. No.: US 2013/0146647 A1
(43) Pub. Date: Jun. 13, 2013

(54) Integrated Reflow and Cleaning Process and Apparatus for Performing the Same

(71) Applicants: Chung-Shi Liu, Hsin-Chu (TW); Chien Ling Hwang, Hsin-Chu (TW); Bor-Ping Jang, Chu-Bei (TW); Ying-Jui Huang, Taipei City (TW)

(72) Inventors: Chung-Shi Liu, Hsin-Chu (TW); Chien Ling Hwang, Hsin-Chu (TW); Bor-Ping Jang, Chu-Bei (TW); Ying-Jui Huang, Taipei City (TW)

(73) Assignee: Taiwan Semiconductor Manufacturing Company, Ltd., Hsin-Chu (TW)

(21) Appl. No.: 13/313,371

(22) Filed: Dec. 7, 2011

(51) Int. Cl. B23K 31/02

(52) U.S. Cl. 228/202; 228/201

(57) ABSTRACT

A method includes reflowing a solder region of a package structure, and performing a cleaning on the package structure at a cleaning temperature higher than a room temperature. Between the step of reflowing and the step of cleaning, the package structure is not cooled to temperatures close to the room temperature.

### BACKGROUND

In the packaging of integrated circuits, solder joining is one of the most commonly used methods for bonding integrated circuit components. In a typical solder joining process for joining two integrated circuit components, the solder on the surface of one, or both, of the integrated circuit components is dipped with flux. The integrated circuit components are then placed together. A reflow is performed to melt the solder, so that the integrated circuit components are bonded together when the solder cools down. After the reflow process, the bonded integrated circuit components may be shipped away to have a cleaning step performed thereon, so that the flux residue may be removed.

### BRIEF DESCRIPTION OF THE DRAWINGS

For a more complete understanding of the embodiments, and the advantages thereof, reference is now made to the following descriptions taken in conjunction with the accompanying drawings, in which:

FIG. 1 is a cross-sectional view of an integrated reflow and cleaning tool in accordance with embodiments;

FIG. 2 schematically illustrates a cross-sectional view of a package structure including two work pieces and a solder region therebetween;

FIG. 3 schematically illustrates a temperature profile of an exemplary integrated reflow and cleaning process; and

FIG. 4 is a cross-sectional view of an integrated reflow and cleaning tool in accordance with alternative embodiments.

### DETAILED DESCRIPTION OF ILLUSTRATIVE EMBODIMENTS

The making and using of the embodiments of the disclosure are discussed in detail below. It should be appreciated, however, that the embodiments provide many applicable inventive concepts that can be embodied in a wide variety of specific contexts. The specific embodiments discussed are merely illustrative, and do not limit the scope of the disclosure.

A method of performing integrated reflow and cleaning processes and the apparatus for performing the same are provided in accordance with various embodiments. The variations and the operation of the embodiments are discussed. Throughout the various views and illustrative embodiments, like reference numbers are used to designate like elements.

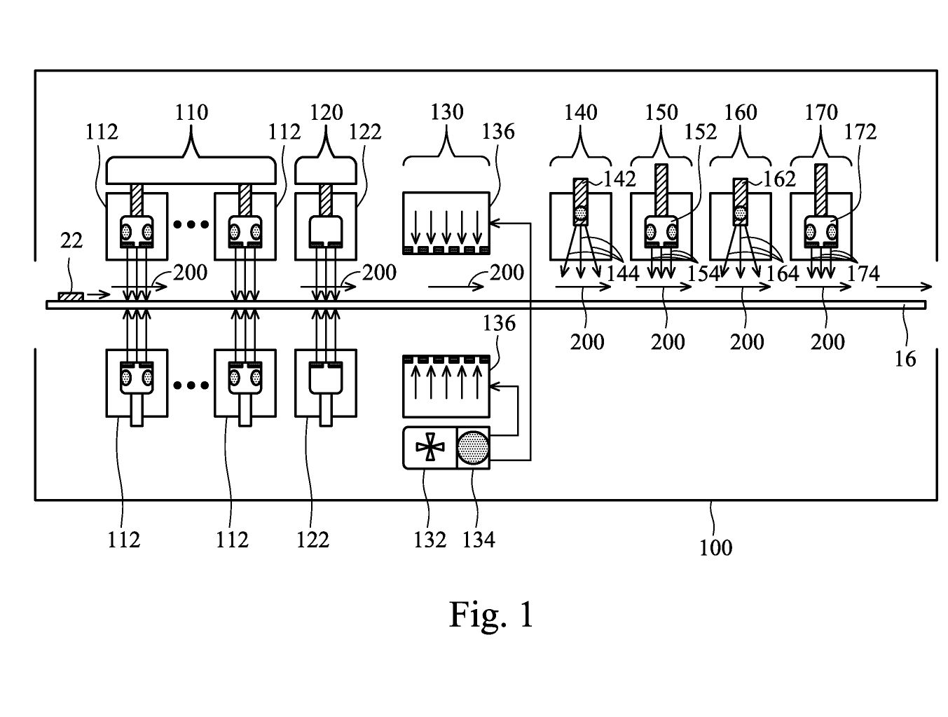

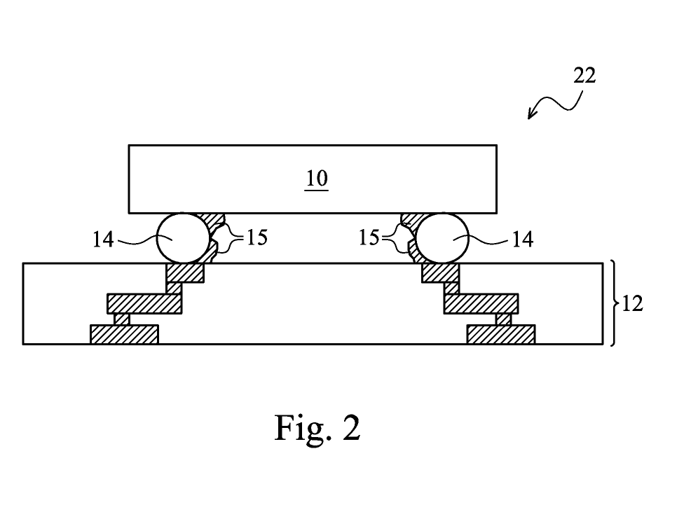

FIGS. 1 illustrates a cross-sectional view of an integrated reflow and cleaning tool in accordance with embodiments, wherein a reflow process and a cleaning process are performed using the integrated reflow and cleaning tool. An exemplary package on which the integrated reflow and cleaning process is performed is shown as package structure 22 as in FIG. 2. FIG. 2 illustrates a schematic view of an exemplary package structure 22, which includes work pieces 10 and 12 and solder-containing regions 14 between work pieces 10 and 12. Work pieces 10 and 12 are to be bonded, for example, through flip-chip bonding. Throughout the description, work piece 10 may be referred to as a device die, and work piece 12 may be referred to as a package substrate. In alternative embodiments, each of work pieces 10 and 12 may be a device die including integrated circuit devices such as transistors therein, a package substrate, an interposer, a printed circuit board (PCB), a package, or the like. It is appreciated that the illustrated structure of package structure 22 is merely an exemplary, and package structures having different designs may be bonded using the integrated reflow and cleaning tool.

FIG. 1 illustrates a convection-type reflow process in accordance with an exemplary embodiment, in which package structure 22 is transferred by conveyor belt 16. It is appreciated that other types of reflow methods other than convection-type reflow may also be used in accordance with embodiments. Conveyor belt 16 transfers package structure 22 through zones 110, 120, 130, 140, 150, 160, and 170, so that the integrated reflow and the cleaning process may be performed. Each of a plurality of arrows 200 represent that package structure 22 is passing through one of zones 110, 120, 130, 140, 150, 160, and 170.

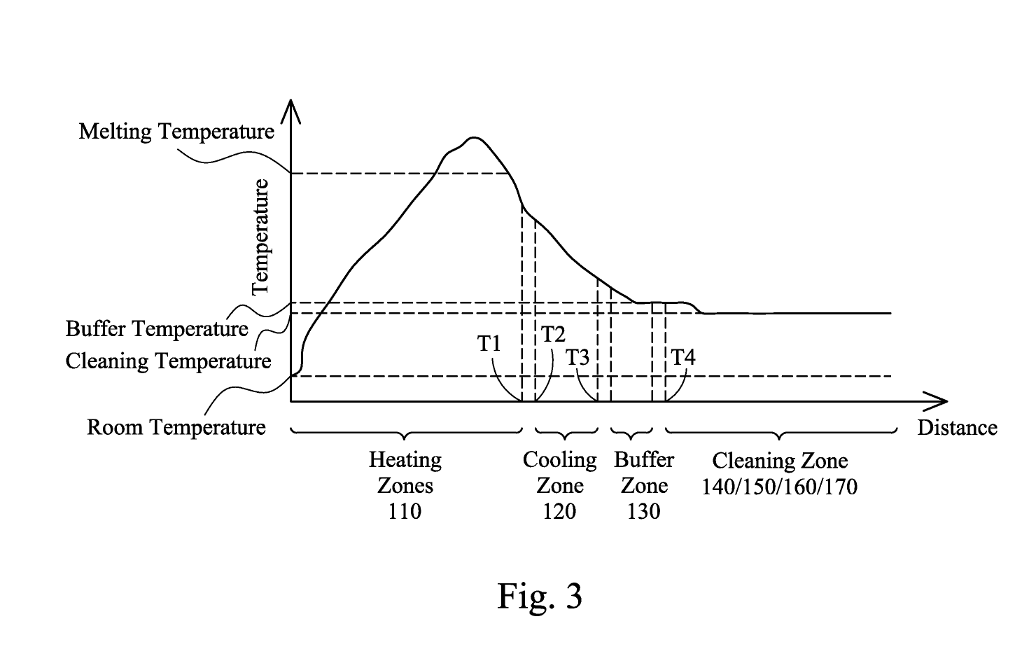

Conveyor belt 16 and zones 110, 120, 130, 140, 150, 160, and 170, and the tools in the respective zones may be disposed in the same chamber/ambient 100. Package structure 22 is first transferred to heating zones 110, which may include a plurality of heat sources 112. When package structure 22 is transferred through heat sources 112, solder-containing regions 14 (FIG. 2), which join work piece 10 to respective underlying work piece 12, are heated to a temperature higher than the melting temperature of solder-containing regions 14, and hence solder-containing regions 14 are molten. In an embodiment, heat sources 112 may be disposed over and/or under package structure 22 (and conveyor belt 16), and the temperature of each of heat sources 112 may be controlled separately from that of other heat sources 112. Heat sources 112 may be radiation-type heating sources such as infrared radiant sources, or may be configured to blow hot air to package structure 22. The arrows pointed away from heat sources 112 symbolize the radiated heat, the hot air, or the like. There may be a plurality of heating zones 110, wherein the total count of heating zones 110 may range from ten to twelve, for example. The temperature profile of package structure 22 is schematically illustrated in FIG. 3, wherein the region marked as “heating zones 110” shows the temperature of package structure 22 is raised above the melting temperature of solder regions 14.

Referring back to FIG. 1, after passing heating zone 110, package structure 22 enters into cooling zone(s) 120, which includes cooling sources 122. In some embodiments, cooling sources 122 comprise blowers that blow air to package structure 22. The air blown to package structure 22 may be at the room temperature, which may be about 21° C., for example, although the actual room temperature may be higher or lower. Cooling sources 122 may also include unit(s) that are over package structure 22, and/or unit(s) that are under package structure 22, as shown in FIG. 1.

Depending on the rate of cooling, there may be a single cooling zone 120, or there may be a plurality of cooling zones 120. In alternative embodiments, there may not by any cooling zone that comprises cool air blowers. Cooling zones 120 are designed to cool the temperature of solder regions 14. For example, at the exiting point of cooling zone(s) 120, the temperature of solder-containing regions 14 may be between about 150° C. and about 50° C.

Referring again to FIG. 1, package structure 22 may then transferred into buffer zone 130, which functions to stabilize the temperature of package structure 22 to a buffer temperature slightly higher than (or equal to) the cleaning temperature for cleaning package structure 22. In an exemplary embodiment, the buffer temperature is between about 80° C. and about 100° C. Buffer zone 130 may include blower(s) 132, and heat generator(s) 134, wherein the heat generated in heat generator 134 is blown to heat boxes 136, which distribute the hot air that is at the buffer temperature to package structure 22. Heat boxes 136 may be disposed above and/or below package structure 22. The length of buffer zone 130 is great enough, so that if cooling zone 120 cools package structure 22 faster or slower than a predetermined rate, and/or conveyor belt 16 is run faster or slower than a desirable speed, such variations in operation may be compensated for by buffer zone 130, and package structure 22 may stably exit buffer zone 130 with the intended buffer temperature. A temperature profile of package structure 22 in buffer zone 130 is shown as region “Buffer zone 130” in FIG. 3.

Referring again to FIG. 1, after existing buffer zone 130, the residue flux (schematically illustrated as 15 in FIG. 2) on package structure 22 is removed in zones 140, 150, 160, and 170, which are referred to clean zones hereinafter. First, package structure 22 enters hot solvent spray zone 140, wherein hot solvent sprayer 142 (which may include a nozzle) may heat a solvent, and spray the hot solvent 144 to package structure 22. The temperature of hot solvent 144 may be close to the cleaning temperature (also see FIG. 3), which is higher than the room temperature, and may be between about 70° C. and about 80° C., although higher or lower temperatures may be used. A temperature difference between the buffer temperature and the cleaning temperature may be smaller than about 20 degrees Celsius, although the temperature difference may be slightly higher.

After the hot solvent spray, package structure 22 enters hot dry zone 150, wherein hot dry air 154 is blown to package structure 22, for example, using blower 152. The temperature of hot dry air 154 may also be close to the cleaning temperature, which may be between about 70° C. and about 80° C., for example.

Next, package structure 22 enters de-ionized (DI) water zone 160, wherein hot DI water sprayer 162 (which may include a nozzle) may heat the DI water, and spray hot DI water 164 to package structure 22. The temperature of hot DI water 164 may be close to the cleaning temperature, which may be between about 70° C. and about 80° C., for example.

After the hot DI water spray, package structure 22 enters hot dry zone 170, wherein hot dry air 174 is again blown to dry package structure 22, for example, using blower 172. The temperature of hot dry air 174 may also be close to the cleaning temperature, which may be between about 70° C. and about 80° C., for example.

FIG. 3 illustrates an exemplary temperature profile, wherein the X axis indicates the traveling distance (which also represents the zones) of package structure 22 in chamber 100 (FIG. 1), and the Y axis indicates the temperatures of package structure 22. Time point T1 is when package structure 22 exits heating zones 110. Time points T2 and T3 are when package structure 22 enters and exits, respectively, cooling zone(s) 120. In some embodiments, the cooling zones is immediately after the heating zones, and hence time points T1 and T2 may be merged as one time point. Time point T4 is when package structure 22 enters hot solvent spray zone 140. Heating zones 110, cooling zone 120, buffer zone 130, and cleaning zones 140/150/160/170 are schematically marked in FIG. 3. In some embodiments, in the entire duration starting from time point T1 to time point T4, the temperature of package structure 22 does not drop to close to the room temperature, and the temperature of package structure 22 may be maintained at about 60° C. or higher. Furthermore, in some embodiments, after exiting cooling zone 120 (FIG. 1) at time point T3, the temperature of package structure 22 may continuously drop to the buffer temperature first, and then maintained substantially stable at the buffer temperature. Furthermore, it is observed that from time point T1 to time point T4, there is no substantial temperature ramping-up occurring to package structure 22, wherein the substantial temperature ramping-up may be the stage during which the temperature of package structure 22 increases more than about 5 degrees Celsius and less than about 100 Celsius. The substantial temperature ramping-up may also be the stage during which the temperature of package structure 22 increases more than about 5 degrees Celsius and less than about 100 Celsius. Accordingly, there is no additional thermal cycle between the reflowing and the cleaning of package structure 22.

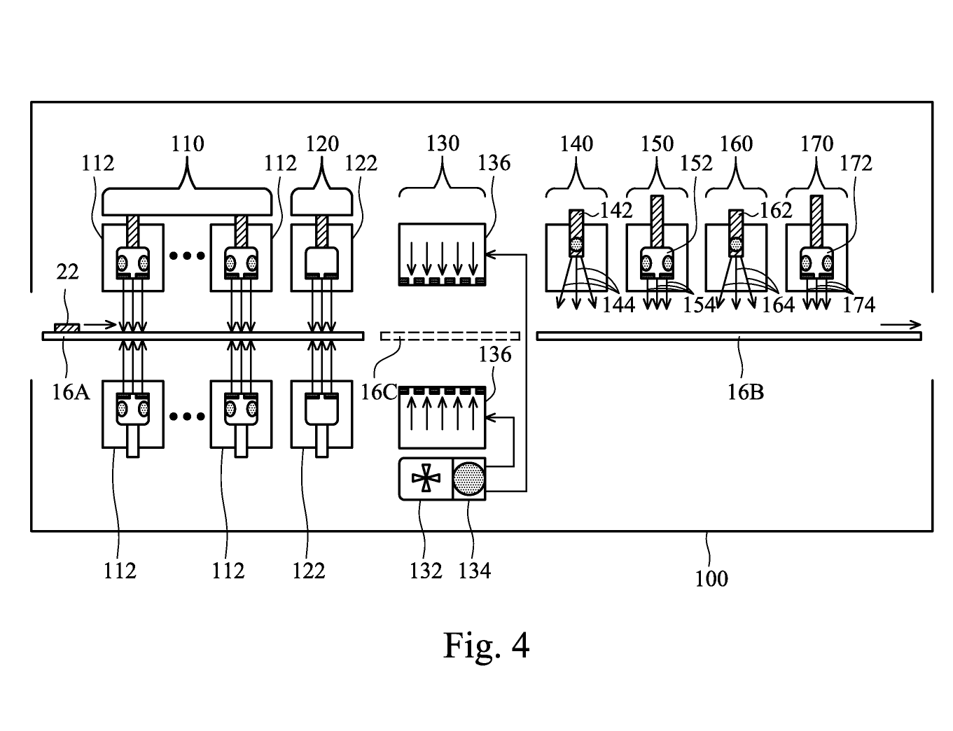

In the embodiments shown in FIG. 1, conveyor belt 16 is illustrated as a single conveyor belt that extends all the way from the beginning of heating zones 110 to the end of hot dry zone 170. In alternative embodiments, conveyor belt 16 may be separated into a plurality of conveyor belts. For example, FIG. 4 illustrates exemplary embodiments, wherein conveyor belt 16A is used to transfer package structure 22 through heating zones 110 and cooling zone(s) 120, while conveyor belt 16B is used to transfer package structure 22 through cleaning zones 140, 150, 160, and 170. Buffer zone 130 may include conveyor belt 16C that is separated from conveyor belts 16A and 16B. Alternatively, buffer zone 130 may share a conveyor belt with heating zones 110 and cooling zone(s) 120, or share a conveyor belt with cleaning zones 140, 150, 160, and 170. Conveyor belt 16C is thus illustrated using dashed lines to indicate that it may be separated from, or merged with, conveyor belt 16A or conveyor belt 16B. Regardless of whether a single one (FIG. 1) or a plurality of (FIG. 4) conveyor belts are used for the integrated reflow and cleaning processes, zones 110 through 170 may be deployed in a single ambient 100, and may be in a single clean room.

In the conventional reflow and cleaning processes, package structures need to go through the reflow processes, and then transported to perform the cleaning process. During the transportation, the package structures are cooled to the room temperature. During the cleaning step, the temperatures of the package structures are ramped up again. Accordingly, an extra thermal cycle occurs between the reflow and the cleaning processes. In the embodiments, however, by integrating the reflow and the cleaning processes, the temperatures of the package structures are not dropped to the room temperature before the cleaning process is performed. Therefore, the package structures experience one fewer thermal cycle than in the conventional processes. In addition, since the flux on the package structures is cleaned right after the reflow, it is easy to clean the flux. Furthermore, by integrating the reflow and the cleaning processes, fewer interface tools such as loaders and un-loaders are needed.

In accordance with embodiments, a method includes reflowing a solder region of a package structure, and performing a cleaning on the package structure at a cleaning temperature higher than a room temperature. Between the step of reflowing and the step of cleaning, the package structure is not cooled to temperatures close to the room temperature.

In accordance with other embodiments, a method includes transferring a package structure into a heating zone to melt a solder region, wherein the package structure includes a first work piece, a second work piece, and the solder region between the first work piece and the second work piece. After the solder region is molten, the package structure is transferred into a cooling zone to cool the solder region to below a melting temperature of the solder region. The package structure is then transferred into a hot solvent spray zone, wherein a flux solvent is sprayed to the package structure. The flux solvent is at a cleaning temperature higher than a room temperature. During the period of time from the solder region is molten to the flux solvent is sprayed to the package structure, no substantial temperature ramping-up occurs to the solder region.

In accordance with yet other embodiments, an integrated reflow and cleaning tool includes a heating zone and a flux clean zone. The heating zone is configured to heat a solder region of a package structure in the heating zone to higher than a melting temperature of the solder region. The flux clean zone is configured to clean a flux on the package structure, wherein the heating zone and the flux clean zone are disposed in a same ambient.

Although the embodiments and their advantages have been described in detail, it should be understood that various changes, substitutions and alterations can be made herein without departing from the spirit and scope of the embodiments as defined by the appended claims. Moreover, the scope of the present application is not intended to be limited to the particular embodiments of the process, machine, manufacture, and composition of matter, means, methods and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized according to the disclosure. Accordingly, the appended claims are intended to include within their scope such processes, machines, manufacture, compositions of matter, means, methods, or steps. In addition, each claim constitutes a separate embodiment, and the combination of various claims and embodiments are within the scope of the disclosure.

1. A method comprising:
reflowing a solder region of a package structure;
maintaining a temperature of the package structure substantially stable at a level lower than a reflowing temperature;
performing a cleaning on the package structure at a cleaning temperature higher than a room temperature, wherein between the step of reflowing and the step of cleaning, the package structure is not cooled to temperatures close to the room temperature.

2. The method of claim 1, wherein the step of reflowing comprises:
heating the package structure to a first temperature higher than a melting temperature of the solder region; and
cooling the package structure to a second temperature lower than the melting temperature of the solder region and higher than the cleaning temperature.

3. The method of claim 2 further comprising, after the step of cooling and before the step of cleaning, stabilizing the temperature of the package structure to a buffer temperature higher than the cleaning temperature.

4. The method of claim 3, wherein a temperature difference between the buffer temperature and the cleaning temperature is smaller than about 80 degrees Celsius.

5. The method of claim 1, wherein the step of cleaning is configured to clean a flux on the package structure.

6. The method of claim 5, wherein the step of cleaning comprises:
a first hot air drying of the package structure;
a de-ionized water cleaning of the package structure; and
a second hot air drying of the package structure.

7. The method of claim 1, wherein at a first time point, the temperature of the package structure reaches a melting temperature of the solder region in the step of reflowing, wherein the step of cleaning starts at a second time point, and wherein between the first time point and the second time point, the package structure is maintained at temperatures not substantially lower than the cleaning temperature.

8. A method comprising:
transferring a package structure into a heating zone to melt a solder region, wherein the package structure comprises a first work piece, a second work piece, and the solder region between the first work piece and the second work piece;
after the solder region is molten, transferring the package structure into a cooling zone to cool the solder region;
maintaining a temperature of the package structure substantially stable at a level lower than a melting temperature of the solder region; and
transferring the package structure into a hot solvent spray zone, wherein a flux solvent is sprayed to the package structure, wherein the flux solvent is at a cleaning temperature higher than a room temperature, and wherein during the period of time from the solder region is molten to the flux solvent is sprayed to the package structure, no substantial temperature ramping-up occurs to the solder region.

9. The method of claim 8 further comprising, between the steps of transferring the package structure into the cooling zone and transferring the package structure into the hot solvent spray zone, transferring the package structure into a buffer zone at a buffer temperature higher than the cleaning temperature, and wherein a temperature difference between the buffer temperature and the cleaning temperature is smaller than about 80 degrees Celsius.

10. The method of claim 9, wherein the buffer zone comprises a first blower over the package structure and a second blower below the package structure, and wherein when the package structure is in the buffer zone, the first and the second blowers blow hot air at the buffer temperature to the package structure.

11. The method of claim 8, wherein between the heating zone and the hot solvent spray zone, there can be a single or no cooling zone that comprises a cool air blower.

12. The method of claim 8 further comprising:
after transferring the package structure into the hot solvent spray zone, transferring the package structure into a first hot air dry zone;
transferring the package structure into a de-ionized water clean zone; and
transferring the package structure into a second hot air dry zone.

13. The method of claim 8, wherein between the step of transferring the package structure into the heating zone and the step of transferring the package structure into the hot solvent spray zone, the package structure is maintained at temperatures higher than a room temperature.

14. An apparatus comprising:
an integrated reflow and cleaning tool comprising:
a heating zone configured to heat a solder region of a package structure in the heating zone to higher than a melting temperature of the solder region; and
a flux clean zone configured to clean a flux on the package structure, wherein the heating zone and the flux clean zone are disposed in a same ambient.

15. The apparatus of claim 14, wherein the integrated reflow and cleaning tool is configured to transferring the package structure from the heating zone to the flux clean zone without allowing the package structure to cool to close to room temperature.

16. The apparatus of claim 14, wherein the flux clean zone is configured to clean the flux at a cleaning temperature, and wherein the integrated reflow and cleaning tool is configured to transfer the package structure from the heating zone to the flux clean zone without allowing the package structure to cool to substantially below the cleaning temperature.

17. The apparatus of claim 14, wherein the flux clean zone comprises:
a hot solvent sprayer;
a first hot air generator and blower;
a de-ionized water sprayer; and
a second hot air generator and blower.

18. The apparatus of claim 14, wherein the flux clean zone comprises a hot solvent sprayer configured to spray a hot flux solvent to the package structure, and wherein the apparatus further comprises:
a cooling zone configured to cool the solder region of the package structure; and
a buffer zone configured to blow hot air at a buffer temperature higher than a temperature of the hot flux solvent.

19. The apparatus of claim 18, wherein the buffer zone comprises a first blower over the package structure and a second blower below the package structure, wherein the first and the second blowers are configured to blow hot air at a temperature between about 80° C. and about 100° C. to the package structure.

20. The apparatus of claim 18 further comprising a conveyor configured to transfer the package structure from the heating zone through the flux clean zone.
